(19) United States
(12) Patent Application Publication
(10) Pub. No.: US 2023/0140441 A1
(43) Pub. Date: May 4, 2023

(54) TARGET ACQUISITION SYSTEM FOR AN INDIRECT-FIRE WEAPON

(71) Applicant: CODE PLANET SAVER OY, Imatra (FI)

(72) Inventor: Arto KOIVUHARJU, Imatra (FI)

(21) Appl. No.: 17/907,693

(22) PCT Filed: Apr. 1, 2021
(86) PCT No.: PCT/FI2021/050243

§ 371 Date: Sep. 29, 2022

(30) Foreign Application Priority Data
Apr. 3, 2020 (FI) 20205352

(51) Int. Cl. F41G 3/16; F41G 3/02; F41G 3/14; B64C 39/02; B64U 20/87

(52) U.S. Cl. CPC F41G 3/165; F41G 3/02; F41G 3/142; B64C 39/024; B64U 20/87; F41G 3/06

(57) ABSTRACT

The application relates to a target acquisition system according to one embodiment for an indirect-fire weapon. The system includes a terminal device, a sensor unit for the terminal device, an unmanned aircraft and a control device for the aircraft. The terminal device is adapted to receive, from the control device-controlled aircraft, location data (LD, PW, DT, LT) related to a target's location (LT). The sensor unit is adapted to monitor the weapon's position. The terminal device is adapted to present, with a user interface unit, the target's location on the basis of the received location data and a calculated hit point (LH) for the weapon's projectile on the basis of the weapon's position. The terminal device is adapted to indicate, with the user interface unit, when the weapon has been aimed in such a way that, on the basis of its position, the projectile's calculated hit point is in alignment with the target's location, whereby, when the weapon is discharged, its projectile strikes the designated target

### TECHNICAL FIELD

The application relates generally to a target acquisition system for an indirect-fire weapon.

### BACKGROUND

Indirect fire refers to shooting at a target performed with indirect-fire weapons, for example mortars or field guns, generally without direct visual contact with the target from the gun emplacement.

The shooting of arcing fire weapons, establishing a fire unit, has been traditionally directed by using an observation team, including the actual observer and observation crew. The observation team makes its way under the cover of surrounding terrain to the proximity of a target, making it possible, by means of a direct line of sight, to determine the target's location coordinates based on its own position. Once determined, the target's coordinates will be transmitted by the observation team over radio or telephone to the firing unit's command post.

It is at the firing unit's command post that the received coordinates are converted into firing data, which are communicated to guns crews at a gun emplacement. The guns are aimed according to the determined data and the crew fires the guns according to orders from the command post.

### SUMMARY

It is one objective of the invention to solve some of the prior art problems and to provide a target acquisition system for indirect fire, which enables safe observation of a target, the easy, assisted aiming of an available weapon at the acquired target, and the reliable destruction of the acquired target without risking the life of a person operating the acquisition system.

The one objective of the invention is attained with a target acquisition system, a terminal device, a target acquisition method, an unmanned aircraft, a target location determination method, a computer program and a computer program product, according to the independent claims.

A few embodiments of the invention include a target acquisition system, a terminal device, a target acquisition method, a computer program and a computer program product, according to the independent claims.

The target acquisition system according to one embodiment of the invention, intended for an indirect-fire weapon, comprises a terminal device, a sensor unit for the terminal device, an unmanned aircraft, and a control device for the aircraft. The terminal device is adapted to receive target location-related location data from an aircraft controlled with the control device. The sensor unit is adapted to monitor a weapon's position. The terminal device is further adapted to display, with a user interface unit, the location of a target on the basis of the received location data and the calculated hit point for a weapon's projectile on the basis of the weapon's position. The terminal device is further adapted to indicate, with the user interface unit, when the weapon has been aimed in such a way that, based on its position, the projectile's calculated hit point coincides with the target's location whereby, when the weapon is discharged, its projectile hits the acquired target.

The terminal device according to one embodiment of the invention, intended for target acquisition for an indirect-fire weapon, includes a data transfer unit which is adapted to receive target location-related location data from an unmanned aircraft controlled with a control device. The terminal device further includes a sensor unit, which is adapted to monitor a weapon's position. The terminal device further includes a user interface unit, which is adapted to display the location of a target on the basis of the received location data and the calculated hit point for a weapon's projectile on the basis of the weapon's position. The user interface unit is further adapted to indicate when the weapon has been aimed in such a way that, based on its position, the projectile's calculated hit point coincides with the target's location whereby, when the weapon is discharged, its projectile hits the acquired target.

The target acquisition method according to one embodiment of the invention, intended for an indirect-fire weapon, comprises a step of receiving, with a terminal device's data transfer unit, target location-related location data from an unmanned aircraft controlled with a control device. The method further comprises a step of monitoring, with the terminal device's sensor unit, a weapon's position. The method further comprises a step of displaying, with the terminal device's user interface unit, the location of a target on the basis of the received location data and the calculated hit point for a weapon's projectile on the basis of the weapon's position. The method further comprises a step of indicating, with the user interface unit, when the weapon has been aimed in such a way that, on the basis of its position, the projectile's calculated hit point coincides with the target's location whereby, when the weapon is discharged, its projectile hits the acquired target.

The unmanned aircraft according to one embodiment of the invention, intended for determining the location of a target for an indirect-fire weapon, is provided with a camera, which is adapted to generate imagery comprising a target. The aircraft is further provided with a data transfer unit, which is adapted to transmit the camera-generated imagery to an aircraft control device. The aircraft is further provided with a data transfer unit, which is adapted to receive a target designation from the control device. The aircraft is further provided with a measuring unit, which is adapted to acquire the camera position and the aircraft's distance to target. The aircraft is further provided with a positioning unit, which is adapted to acquire aircraft position data for the determination of target location-related location data by means of the camera position, the distance between aircraft and target, and the position data.

The target location determining method according to one embodiment of the invention, intended for an indirect-fire weapon, comprises a step of generating, with an unmanned aircraft-mounted camera, imagery comprising a target. The method further comprises a step of transmitting, with an aircraft-mounted data transfer unit, the camera-generated imagery to an aircraft control device. The method further comprises a step of receiving, with a data transfer unit, a target designation from the control device. The method further comprises a step of acquiring, with an aircraft-mounted measuring unit, a camera position and the aircraft's distance to target. The method further comprises a step of acquiring, with an aircraft-mounted positioning unit, aircraft position data for the determination of target location-related location data by means of the camera position, the distance between aircraft and target, and the position data.

The computer program according to one embodiment of the invention, intended for target acquisition for an indirect-fire weapon, includes instructions which enable a computer to execute the steps of a target acquisition or target location determining method of the preceding embodiment as the program is run on a computer.

The computer program product according to one embodiment of the invention, intended for target acquisition for an indirect-fire weapon, has a computer program according to the preceding embodiment stored therein.

Other embodiments of the invention are presented in the dependent claims.

Some exemplary embodiments of the invention are also subsequently presented in more detail by means of the accompanying figures.

### BRIEF DESCRIPTION OF THE FIGURES

Some exemplary embodiments of the invention will be described more precisely hereinafter with reference to the accompanying figures:

FIG. 1 shows a target acquisition system

FIG. 2 shows the functional components of an unmanned aircraft and a weapon user's terminal device

### DETAILED DESCRIPTION OF THE FIGURES

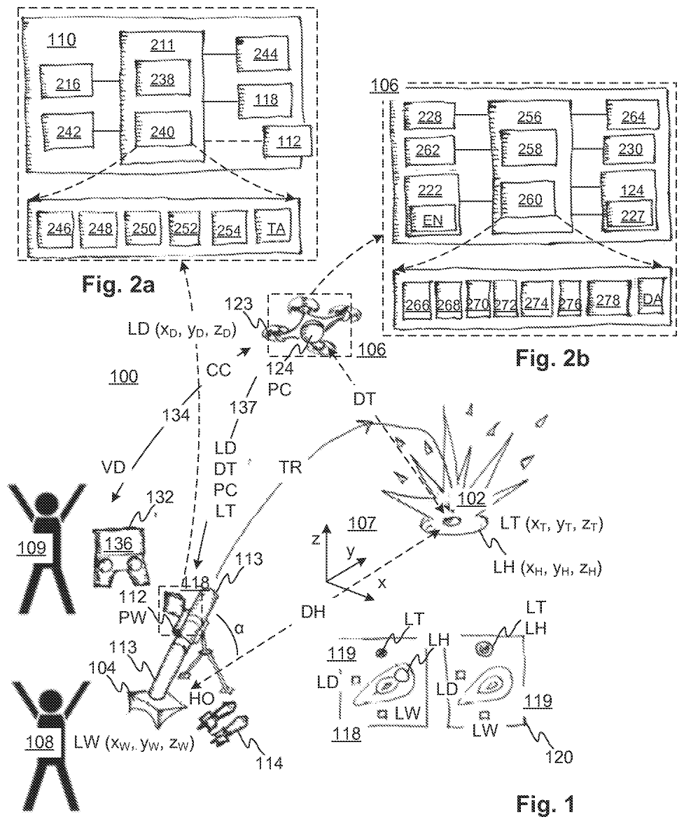

FIG. 1 shows a target acquisition system 100, which is intended for acquiring a target (object) 102 for at least one firearm 104 intended for shooting indirect fire.

The target acquisition is conducted by using an unmanned aircraft (a drone, Unmanned Aircraft UA) 106, enabling acquisition of the target's 102 location (location data) LT (x_{T}, y_{T}, z_{T}) without a user of the gun (shooter) 108, or especially an operator (target designator) 109 of the drone 106 used for target acquisition, being in direct visual contact with the target 102, whereby the user 108 or the operator 109 are also not exposed to possible direct fire coming from the target 102 or its vicinity.

The indirect fire shooting weapon 104 is e.g. a rifle intended for shooting a rifle grenade, a rifle equipped with a grenade launching device, a machine gun, an automatic grenade launcher, a mortar 104 as shown in the figure, a rocket launcher, a field gun or howitzer; an antitank bazooka, missile or gun; the main weapon of a tank or armored vehicle; an antiaircraft cannon, machine gun or missile; or a self-propelled, coastal or naval gun.

As depicted in the figure, the at least one weapon 104 comprises one, two, three, four or more weapons 104.

The drone 106 is an aircraft without a human pilot and it is in the type of e.g. an unmanned aerial vehicle (airplane), a multicopter 106 as shown in the figures, a blimp, a captive balloon or the like type of aircraft.

The system 100 includes a portable terminal device 110 for the user 108 of the weapon 104, at least a part of said device being attached to the weapon 104 or, as shown in the figure, the terminal device 110 is attached in its entirety to the weapon 104.

The user 108 comprises at least one user 108 participating in deployment of the weapon 104, e.g. as shown in the figure, one, two, three, four or more users 108.

The terminal device 110 comprises a control unit 211, which is intended for making up a three-dimensional (3D) coordinate system 107 which is utilized by the terminal device in computation needed for pinpointing and acquiring the target 102.

The terminal device 110 further comprises a sensor unit 112, which is attachable to the weapon 104 and intended for monitoring the position (aiming, orientation) of e.g. the weapon's 104 barrel or, as shown in the figure, tube 113 through which a projectile 114 travels in the weapon 104, and for determining (procuring) a position (position data) PW of the weapon 104.

The sensor unit 112 comprises at least one position sensor intended for detecting a position, e.g. one, two, three, four or more sensors. The sensor is e.g. an acceleration sensor.

The terminal device 110 further comprises a positioning unit 216, which is intended for monitoring the location of the terminal device 110 itself and, at the same time, that of the weapon 104 and for determining the location (location data) LW (x_{W}, y_{W}, z_{W}) of the terminal device 110 and the weapon 104, i.e. for pinpointing at the same time both itself and the weapon 104 in the coordinate system 107. It is for locating the weapon 104 that the positioning unit 216 makes use of e.g. satellite navigation, e.g. Global Positioning System (GPS), Glonass, Galileo or Beidou positioning system, or Global System for Mobile Communications (GSM) positioning.

The terminal device 110 further comprises a user interface unit (user interface) 118, e.g. a touch screen or display, which is intended for presenting the user 108 with a two-dimensional (2D) or 3D map view (display) 120 of the weapon's 104 location area 119 based on the weapon's 104 location determined by means of the positioning unit 216. By means of the map view 120 it is possible to present, as shown in the figure, the weapon 104 in the area 119.

According to the figure, the sensor unit 112 is integrated with the terminal device 110 in such a way that the sensor unit 112 is protected by the structure of the terminal device 110 from mechanical shocks and effects of the environment, e.g. the weather. Alternatively, the sensor unit 112 is designed as a shield structure-protected discrete entity, which communicates, by way a cable connection, a wireless radio link, or both, the position PW to the portable terminal device 110 spaced from the weapon 104, to be processed by the control unit 211 and to be presented by the user interface 118.

In the system 100, it is the terminal device 110 which calculates, by means of the control unit 211, a trajectory TR for the projectile 114 on the basis of a position PW of the weapon 104, i.e. in the illustrated case, that of the tube 113, enabling the determination of an angle of inclination a between an xy-plane (horizontal plane) HO and the weapon 104 (tube 113), as well as on the basis of predetermined ballistic data for the weapon 104 and each projectile type.

Thereafter, the terminal device 110 further calculates, by means of the control unit 211, a hit point LH (x_{H}, y_{H}, z_{H}) for the projectile 114 on the basis of a position PW of the weapon 104 acquired by the sensor unit 112, a location LW of the weapon 104 acquired by the positioning unit 216, a calculated trajectory TR. and elevation data which are co-directional with a z-axis of the area 119 and determine the location of each map point on the z-axis.

Once the hit point LH has been calculated, it is by means of the user interface 118 that the terminal device 110 shows the operator 108 in the map view 120 which hit point LH within the area 119, calculated on the basis of a position PW of the weapon 104, will be struck by the projectile 114 if the weapon 104 is discharged in the weapon's current orientation (position PW).

In the system 100, it is the terminal device 110 which updates, on the user interface 118, the calculated hit point LH for the weapon 104 continuously or on the basis of a separate command issued by the user 108 over the user interface 118 every time the weapon's 104 location LW, position PW or both are changed, whereby, when the terminal device 110 is operating, the user 108 is constantly aware of where it is possible to shoot with the weapon 104 in its current position PW.

The system 100 further includes an unmanned drone 106 as mentioned above, which is equipped with a camera unit 124 and intended for detecting a target 102 and for determining its location LT.

The drone 106 comprises a flight unit 222, which is intended for generating the power needed for movement of the drone 106 in the air, and for directing the movement achieved by the power in accordance with commands CC given by the operator 109. The flight unit 222 comprises an engine EN and at least one rotor 123 or propeller rotated by its output, e.g. one, two, three, four as shown in the figure, or more rotors 123 or propellers.

The drone 106 further comprises a camera 124 as mentioned above, which is intended for producing video imagery VD for detecting a target 102 and for marking the target 102 in order to acquire its location LT for the terminal device 110. It is by means of the video imagery VD that the operator 109 of the drone 106 is able to monitor surroundings of the flyable drone 106 and to detect the target 102 from afar without the operator 108, 109 being physically detected. As shown in the figure, the operator 109 can be a separate operator or a user 108 in charge of operating the drone 106.

The camera 124 is equipped with a multi-axis, e.g. two- or three-axis, gimbal (stabilizer) 227, which is intended for steadying the camera 124 for producing stable video image VD while moving. The stabilizer 227 is equipped with an automated tracking system for the target 102, enabling the operator 109 to use the camera 124 for tracking and panning the moving target 102.

The drone 106 further comprises a positioning unit 228, which is intended for monitoring location of the drone 106 and for determining its location (location data) LD (x_{D}, y_{D}, z_{D}), i.e. for pinpointing the drone 106 in the coordinate system 107. The positioning unit 228 makes use of satellite navigation, e.g. a GPS, Glonass, Galileo, or Beidou satellite navigation system, or GSM navigation.

The drone 106 further comprises a measuring unit 230, which is intended for determining a distance DT between the drone 106 (camera 124) and the target 102 which has been detected and marked by means of video image VD transmitted by the camera 124. The measuring unit 230 comprises an optical rangefinder, e.g. a laser rangefinder or an ultrasonic rangefinder.

The measuring unit 230 is further intended for monitoring the camera's 124 position (direction, orientation) and for determining the camera's 124 position (position data) PC in 3D-space while acquiring the distance DT. Therefore, the measuring unit 230 further comprises at least one position sensor intended for detecting a position, e.g. one, two, three, four or more sensors. The sensor is e.g. an acceleration sensor.

In the system 100, it is the distance DT and the position PC acquired by the measuring unit 230 and the location LD acquired by the positioning unit 228 which enable the location LT of the target 102 to be determined.

The system 100 further includes a portable control device (remote, online controller) 132 for the drone 106, which enables the operator 109 to control the operation of at least the drone 106 and its camera 124 with control commands CC issued by him/herself over a wireless, two-way radio link 134 and to receive data VD therefrom.

The remote controller 132 comprises a user interface 136, e.g. a touch screen or a display, and control elements, e.g. controllers and/or function keys, by means of which the operator 109 is able to issue control commands CC for controlling the functions of at least the drone 106 and its units 124, 222, 230 and for marking the target 102, visible in the video image VD, with a control command CC for acquiring its location LT.

In the system 100, the operator 109 controls the drone 106 with a remote controller 132 by means of a video image VD transmitted by its camera 124 while aerially surveying vicinity of the weapon 104 in the area 119. While moving (flying), the drone 106 monitors constantly its location LD.

Alternatively, the control of the drone 106 can be implemented in such a way that the drone 106 moves autonomously (automatically) on the basis of predetermined control without being continuously controlled by the operator 109. In this case, the drone 106 is pre-controlled to move at a specific flight altitude, at a specific distance from the weapon 104, and at a specific direction (angle) relative to the weapon 104, e.g. in exact alignment with the weapon 104 or at some predetermined angle with respect to the weapon's 104 position PW in the xy-plane HO.

The movement of an autonomous drone 106 is controlled by the aforesaid predetermined control and by a location LW of the weapon 104 received from the control device 110, unlike in the figure, by way of a two-way wireless radio link 137, whereby, when the weapon's 104 location LW changes, the drone 106 moves the same way, retaining its flight altitude, distance to the weapon 104 and position (angle) with respect to the weapon 104. It is a benefit of the autonomous drone 106 that the user 108, and possibly the operator 109, will be able to concentrate not on controlling the drone 106 but instead on e.g. sensory observation of the surroundings, as well as on moving, deploying and shooting the weapon 104.

Upon detecting a target 102 from a video image VD presented by the user interface 136, the operator 109 marks the target 102 from the video image VD, the drone's 106 measuring unit 130 determining a distance DT of the camera 124 to the target 102 and a current position PC of the camera 124, indicating in which direction the target 102 lies at the distance DT in a view from the drone's 106 location LD.

After determining the distance DT and the position PC, the drone 106 transmits the data DT, PC, along with its own location LD, to the terminal device 110 by way of a wireless one- or two-way radio link 137, as shown in the figure, or alternatively calculates a location LT of the target 102 on the basis of data items LD, DT, PC and transmits those to the terminal device 110 by way of the radio link 137.

It is in the vicinity of the weapon 104 that the terminal device 110 receives the data items LD, DT, PC transmitted by the drone 106 and calculates the target's 102 location LT itself or, when the location LT is calculated by the drone 106, merely receives it.

Once a location LT of the target 102 is acquired, the terminal device 110 presents, by means of its user interface 118, the user 108 with the target's 102 location LT in a map view 120, whereby the user 108 is at least shown at which hit point LH, calculated on the basis of a current position PW of the weapon 104, the projectile 114 shall strike in the area 119 and the current location LT of the target 102.

In addition to the above, it is possible in the system 100 for the user 108 to present, by means of the user interface 118, in the map view 120 a current location LW of the weapon 104, a current location LD of the drone 106, or both as depicted in the figure.

In the system 100, in a manner similar to a calculated hit point LH for the weapon 104, the location of the target 102 is being updated by the terminal device 110 continuously or on the basis of a separate command issued by the user 108 over the user interface 118 or a control command CC issued by the operator 109 over the user interface 136 every time the drone's 106 location, the target's 102 distance DT, or the camera's 124 position are changed, whereby the user 108 shall see, when the terminal device 110 is operating, from the user interface 118 where the target 102 lies in the area 119 at that moment.

In case the user interface 118 indicates in its map view 120 that the calculated hit point LH for the weapon 104 is not in alignment with a location LT of the target 102 designated by the operator's 109 marking in accordance with an embedded map view 120 on the left, the user 108 would not hit the target 102 or its immediate vicinity when firing with the weapon 104.

In the system 100, it is by means of a map view 120 updating in real time and presented by the terminal device 110 on the user interface 118 that the user 108 is able to re-aim the weapon 104, i.e. to change its position PW, whereby the changes in the weapon's 104 position PW will be updated as a shift of the hit point LH in the map view 120.

Once a position PW of the weapon 104 has been changed by the user 108, whereby the calculated hit point LH is displaced accordingly in such a way that the hit point LH is in alignment with the target's 102 location LT marked by the operator 109 in accordance with an embedded map view 120 on the right, or the location LT is within the impact area of a projectile 114, the result of firing the weapon 104 is the projectile 114 striking the target 102 or its immediate vicinity with the target being damaged or destroyed.

It is the visuality of the system 100 which facilitates and expedites the work of a user 108 in the process of aiming the weapon 104 as the user 108 receives immediate feedback about successful aiming over the user interface 118.

The user interface 118 is capable of displaying to the user 108 visually in the map view 120 when the weapon has been aimed in such a way that, when shooting therewith, the projectile 114 hits the target 102 or its immediate vicinity, e.g. by having map symbols for the location LT, the hit point LH, or both repeatedly switched off and back on, or by changing the colors, tones, brightness or size of map symbols for the location LT, the hit point LH, or both, whereby the terminal device 110 facilitates and ensures hitting the target 102 when shooting with the weapon 104 by instructing the user 108 to shoot when the weapon 104 is correctly aimed.

FIG. 2a shows a principle view of a terminal device 110 intended for facilitating and expediting the aiming of a weapon 104 presented in connection with the preceding figure and usable in the system 100.

The terminal device 110 comprises the aforementioned control unit 211, by means of which the terminal device 110 controls its own operation, i.e. the operation of its components 112, 118, 216, 242, 244, such that the terminal device 110 operates as described in connection with the preceding figure.

The control unit 211 includes a processor element 238, which is used for executing control commands determined by application programs, e.g. an application TA, and possibly by a user 108 of the terminal device 110, as well as for processing information. The processor element 238 includes at least one processor, e.g. one, two, three or more processors.

The control unit 211 further includes a memory element (memory) 240, in which are stored application programs, e.g. TA, controlling the operation of and used by the terminal device 110, as well as information usable in the operation. The memory 240 includes at least one memory, e.g. one, two, three or more memories.

The terminal device 110 further comprises a power supply element (power supply) 242, e.g. at least one battery, by means of which the terminal device 110 derives its necessary operating current. The power supply 242 is in communication with the control unit 211 which controls its operation.

The terminal device 110 further comprises a data transfer unit 244, by means of which the terminal device 110 transmits control commands and information at least to its other components 112, 118, 216, 242 and receives information sent by the latter and by the drone 106. The data transfer unit 242 is in communication with the control unit 211 which controls its operation. Data transfer out of the terminal device 110 and from outside to the terminal device 110 takes place by the utilization of wireless communication links. Data transfer, e.g. with the drone 106, takes place over a radio link 137. Data transfer within the terminal device 110 occurs by the utilization of fixed cable connections but, when the sensor unit 112 is separate from the rest of the terminal device 110, the data transfer therebetween takes place by way of a fixed cable connection or a wireless communication link, e.g. a radio link.

The terminal device 110 further comprises the aforementioned user interface 118, by means of which the user 108 issues to the terminal device 110, especially to the control unit 211, control commands and information needed thereby, as well as receives from the terminal device 110 information, instructions and control command requests presented thereby. The user interface 118 is in communication with the control unit 211 which controls its operation. The user interface 118 includes at least a display or a touch screen and at least one physical function key.

The terminal device 110 further comprises a sensor unit 112 as presented in connection with the preceding figure, which is a separate entity or integrated with the terminal device 110, and by means which the terminal device 110 monitors and determines a position PW of the weapon 104, and a positioning unit 216, by means of which the terminal device 110 monitors and determines its own and the weapon's 104 location LW.

The memory 240 is provided with a user interface application 246 controlling the operation of the user interface 118, a power supply application 248 controlling the operation of the power supply 242, a data transfer application 250 controlling the operation of the data transfer unit 244, a sensor application 252 controlling the operation of the sensor unit 112, a positioning application 254 controlling the operation of the positioning unit 216, and an application (computer program) TA to be utilized in target acquisition and in the process of aiming the weapon 104.

The application TA comprises a computer program code (instructions), which is used for controlling the terminal device 110 as described in connection with the preceding figure, when the application TA is executed in the terminal device 110 jointly with the processor element 238 and the memory 240 included in the control unit 211.

The application TA is stored in the memory 240 or can be designed as a computer program product by recording it on a storage medium readable with a computer, e.g. with the terminal device 110.

FIG. 2a shows a principle view of a drone 106 intended for safe, easy, and quick acquisition and localization of a target 102 presented in connection with the preceding figures and usable in the system 100.

The drone 106 comprises a control unit 256, by means of which the drone 106 controls its own operation, i.e. the operation of its components 124, 222, 227, 228, 230, 262, 264, in such a way that the drone 106 functions as described in connection with the preceding figures.

The control unit 256 includes a processor element 258, which is used for executing control commands determined by application programs, e.g. an application LA, and possibly by an operator 109 of the drone 106, as well as for processing information. The processor element 258 includes at least one processor, e.g. one, two, three or more processors.

The control unit 256 further includes a memory element (memory) 260, in which are stored application programs, e.g. LA, controlling the operation of and used by the drone 106, as well as information usable in the operation. The memory 260 includes at least one memory, e.g. one, two, three or more memories.

The drone 106 further comprises a power supply element (power supply) 262, e.g. at least one battery, by means of which the drone 106 derives its necessary operating current. The power supply 262 is in communication with the control unit 256 which controls its operation.

The drone 106 further comprises a data transfer unit 264, by means of which the drone 106 transmits control commands and information to its other components 124, 222, 227, 228, 230, 262, 264 and to a remote controller 132 and receives control commands information sent thereby. The data transfer unit 264 is in communication with the control unit 256 which controls its operation. Data transfer out of the drone 106 and from outside to the drone 106 takes place by the utilization of wireless communication links. Data transfer e.g. with the remote controller 132 and the terminal device 110 takes place over a radio link 134, 137. Data transfer within the drone 106 occurs by the utilization of fixed cable connections.

The drone 106 further comprises, as presented in the preceding figure, a flight unit 222 by means of which the drone generates the power needed for its movement and orientation, a camera 124 for producing video imagery VD, a stabilizer 227 for steadying the camera 124, a positioning unit 228 by means of which the drone 106 detects and determines its location LD, and a measuring unit 230 by means of which the drone 106 determines a distance DT to the target 102, as well as detects and determines a position PC of the camera 124 in order to enable a location LT of the target 102 to be determined either in the terminal device 110 or in the drone 106 by means of the control unit 256.

The memory 260 includes a power supply application 266 controlling the operation of the power supply 262, a data transfer application 268 controlling the operation of the data transfer unit 264, a camera application 270 controlling the operation of the camera 124, a stabilizer application 272 controlling the operation of the stabilizer 227, a flight application 274 controlling the operation of the flight unit 222, a measurement application 276 controlling the operation of the measuring unit 230, a positioning application 278 controlling the operation of the positioning unit 228, and an application (computer program) LA to be utilized in the process of determining a location LT of the target 102.

The application LA comprises a computer program code (instructions), which is used for instructing the drone 106 to operate as described in connection with the preceding figures, when the application LA is executed in the drone 106 jointly with the processor element 258 and the memory 260 included in the control unit 256.

The application LA is stored in the memory 260 or can be designed as a computer program product by recording it on a storage medium readable with a computer, e.g. with the drone 106.

The drone's 106 user interface is included in the remote controller 132, which is described in connection with the preceding figures and used in controlling the drone, and which comprises its control unit provided with processor and memory elements, a data transfer unit, and the aforementioned user interface 136 by which the operator 109 issues to the drone 106, especially to its control unit 256, control commands CC and information needed thereby, as well as receives from the drone 106 the video imagery VD, information, instructions and control commands by way of a radio link 134.

The foregoing only discloses a few exemplary embodiments of the invention. The principle according to the invention may naturally be varied within the scope of protection defined by the claims, regarding e.g. implementation details and fields of use.

1. A target acquisition system for an indirect-fire weapon, comprising
a terminal device,
a sensor unit for the terminal device,
an unmanned aircraft and
a control unit for the aircraft,
said terminal device being adapted to receive, from the control unit-controlled aircraft, location data (LD, PC, DT, LT) related to a target's location (LT),
said sensor unit being adapted to monitor the weapon's position,
said terminal device being adapted to present with a user interface unit (118) the target's location on the basis of the received location data and a calculated hit point (LH) for a projectile of the weapon on the basis of the weapon's position, and
said terminal device being adapted indicate with the user interface unit when the weapon is aimed in such a way that, on the basis of its position, the projectile's calculated hit point is in alignment with the target's location, whereby, when shooting with the weapon, its projectile hits the designated target.

2. A system according to claim 1, wherein an operator of the aircraft equipped with a camera determines and marks a target on the basis of a camera-transmitted image (VD) presented with the control unit's user interface element, whereby the aircraft's measuring unit acquires the camera's position and the aircraft's distance (DT) to the target.

3. A system according to claim 2, wherein the aircraft acquires its location data (LD) and transmits it along with position and distance data (PC, DT), as location data (LD, PC, DT), to the terminal device which determines, on the basis thereof, the location of a designated target and presents the determined location with its user interface unit.

4. A system according to claim 2, wherein the aircraft acquires its location data (LD), determines on the basis thereof and on the basis of position and distance data (PC, DT) a target's location, and transmits the location data to the terminal device which determines, on the basis thereof, the location of a designated target and presents the determined location with its user interface unit.

5. A system according to claim 1, wherein, upon receiving, from the aircraft, new location data (LT) related to a designated target, the terminal device presents the target's current location with its user interface unit.

6. A system according to claim 1, wherein, upon detecting a change in the aiming of a weapon, the sensor unit generates new position data (PW) on the basis of which the terminal device calculates, on the basis of a new aiming of the weapon, the current hit point (LH) and presents it with its user interface unit.

7. A system according to claim 1, wherein the sensor unit is set in integration with the terminal device in such a way that the sensor unit is protected by the terminal device's structure.

8. A system according to claim 1, wherein the weapon is a rifle intended for shooting a rifle grenade, a rifle equipped with a grenade launching device, a machine gun, an automatic grenade launcher, a mortar 104, a rocket launcher, a field gun or howitzer; an antitank bazooka, missile or gun; the main weapon of a tank or armored vehicle; an antiaircraft cannon, machine gun or missile; a self-propelled, coastal or naval gun.

9. A system according to claim 1, wherein the terminal device is adapted to transmit, to the aircraft, location data (LW) related to a location of the terminal device, and the aircraft is adapted to move autonomously on the basis of a control predetermined by the operator and the terminal device location data received by the aircraft.

10. A terminal device for acquiring a target for an indirect-fire weapon, said device comprising
a data transfer unit, which is adapted to receive, from an unmanned aircraft controlled with a control device, location data (LD, PC, DT, LT) related to a location (LT) of the target,
a sensor unit, which is adapted to monitor the weapon's position,
a user interface unit, which is adapted to present the target's location the basis of the received location data and a calculated hit point LH) for the weapon's projectile on the basis of the weapon's position, and
a user interface unit, which is adapted to indicate when the weapon has been aimed in such a way that, on the basis of its position, the projectile's calculated hit point is in alignment with the target's location, whereby, when the weapon is discharged, its projectile strikes the designated target.

11. A target acquisition method for an indirect-fire weapon, comprising
receiving, with a data transfer unit of a terminal device, from an unmanned aircraft controlled with a control device, location data (LD, PC, DT, LT) related to a target's location LT),
monitoring, with the terminal device's sensor unit, the weapon's position, presenting, with the terminal device's user interface unit, the target's location on the basis of the received location data and a calculated hit point (LH) for the weapon's projectile on the basis of the weapon's position, and
indicating, with the user interface unit, when the weapon has been aimed in such a way that, on the basis of its position, the projectile's calculated hit point is in alignment with the target's location, whereby, when the weapon is discharged, its projectile strikes the designated target.

12. An unmanned aircraft for determining a location (LT) of a target for an indirect-fire weapon, said aircraft including
a camera, which is adapted to produce an imagery (VD) comprising the target,
a data transfer unit, which is adapted to transmit the camera-generated imagery to an aircraft control device
a data transfer unit, which is adapted to receive a designation of the target from the control device,
a measuring unit, which is adapted to acquire the camera's position and the aircraft's distance (DT) to the target, and
a positioning unit, which is adapted to acquire the aircraft's location data (LD) for determining target-related location data (LD, PC, DT, LT) by means of the camera's position, the distance between aircraft and target, and the location data.

13. A determination method for a location (LT) of a target for an indirect-fire weapon, comprising
producing, with an unmanned aircraft's camera, an imagery (VD) comprising the target,
transmitting, with the aircraft's data transfer unit, the camera-generated imagery to the aircraft's control device,
receiving, with the data transfer unit, a designation of the target from the control device,
acquiring, with the aircraft's measuring unit, the camera's position and the aircraft's distance to the target, and
acquiring, with the aircraft's positioning unit, the aircraft's location data (LD) for determining target location-related location data (LD, PC, DT, LT) by means of the camera's position, the distance between aircraft and target, and the location data.

14. A computer program (TA, LA), including instructions which enable a computer to execute the steps of a method set forth in claim 11, when the program is run on the computer.

15. A computer program product, in which is stored a computer program (TA, LA) according to the preceding claim.
